(19) United States
(12) Patent Application Publication
(10) Pub. No.: US 2005/0031758 A1
(43) Pub. Date: Feb. 10, 2005

(54) Dried cheese snack and methods of making the same

(76) Inventor: Paul Scharfman, Madison, WI (US)

Correspondence Address: Alan D. Kamrath;Rider Bennett, LLP, Suite 2000, 333 South Seventh Street, Minneapolis, MN, 55402, US

(21) Appl. No.: 10/637,879

(22) Filed: Aug. 8, 2003

(51) Int. Cl. A23C 19/00

(52) U.S. Cl. 426/582

(57) ABSTRACT

A dried cheese snack (10, 30) with a body made from minced nonmelting cheese pieces (15) unified into a shape, such as a disk or a hexahedron, having a top (27, 47) and a bottom (29, 49), has the top (27, 47) generally parallel with the bottom (29, 49). The minced nonmelting cheese pieces (15) have a final moisture content evenly dispersed throughout the body of about 2% to 8%. Corners as viewed from the top (27, 47) of the cheese product (10, 30) on the cheese product (10, 30) are rounded to promote even drying. The top (27, 47) is between ⅛ and ½ inch from the bottom (29, 49). A method of making the dried cheese cheese snacks (10, 30) by mincing the nonmelting cheese into minced nonmelting cheese pieces (15) is also provided. A form (11, 31) in a forming board (12, 32) is filled with the plurality of minced nonmelting cheese pieces (15). Sausage pieces, meat protein, bacon bits, eggs pieces and soy protein pieces may be used as inlays (35) with the minced nonmelting cheese pieces (15). The inlays (35) and/or minced nornmelting cheese pieces (15) are dried to a moisture content of 8% or less to form the cheese snack (10, 30) of a unitized body.

### FIELD OF THE INVENTION

The present invention relates generally to food dairy products, particularly to cheese products, and specifically to a snack food formed from minced pieces of nonmelting cheese and to a process for making the snack food formed from minced pieces of nonmelting cheese.

### BACKGROUND

Cheese snacks are a popular form of snack food. Generally, cheese snacks that are crunchier and have more volume and more air are more desirable. Also desirable are inlay items such as sausage pieces, meat protein, bacon bits, egg pieces and soy protein pieces to give the cheese snack a unique and appetizing flavor and texture. The control of salt content is also important for texture, flavor and dietary reasons.

Prior art techniques and products have problems creating a cheese snack that has a desirable volume and a desirable amount of air and crunch. Also, the addition of other inlay items such as sausage pieces, meat protein, bacon bits, egg pieces and soy protein pieces are prohibited in prior art cheese snacks because their incorporation in the snack promotes breakage. While some level of salt is desirable, the prior art also has had to use salt to promote even texture and facilitate the slicing of the cheese thereby creating an undesirably salty snack.

Additionally, during the manufacture of nonmelting cheese products of the monolithic slice type, the breakage of the cheese snack anywhere during the manufacturing process reduces the marketability of the piece and may render the piece unusable.

Cheese snacks are made principally of cheese. Cheese is a milk-based product. One conventional way to form a dried milk-based product is to, prior to drying, mix with milk a large portion (26% or more by weight) of a farinaceous material or other binder. Another way to form dried milk pieces, without the use of a binder, is to dry a water and powdered milk slurry using thermal energy. A cheese and water slurry may be dried using either radiant heat or hot oil. These processes for drying milk-based products may involve the spreading of a thin layer of a water mixture in a warm environment. This has high potential for the growth of pathogenic bacteria (e.g. Listeria) that multiply rapidly in a moist, nutrient-dense environment where the temperature is less than 140° F. (60.0° C.).

Cheese products may be dried by a number of methods, including freeze drying, thermal drying, spray drying, or by being heated in hot oil.

It is known to treat pieces of a meltable cheese with thermal predrying and with final microwave heating to create a puffed dried cheese piece, see U.S. Pat. No. 4,803,090 entitled “Process for Producing a Microwave Puffed Cheese Snack” issued Feb. 7, 1989 to Schlipalius et al. However, the methods therein disclosed employs a meltable cheese rather than a nonmelting cheese. The finished product obtained by practicing this method can be characterized as amorphous in shape having been in a puffed or leavened molten state during processing and having a puffed crunchy texture. The '090 patent does not teach methods for producing a finished dried cheese piece product having a dimensional configuration substantially similar to the initial cheese pieces from which the finished product is prepared.

It is known to make a dried piece of cheese substantially in the form of a slice and other monolithic forms, see U.S. Pat. No. 5,795,613 entitled “Dried Cheese Piece of Nonmelting Cheese and Process of Making the Same” to Scharfinan et al., that is incorporated by reference hereto. This method is sensitive to cheese size and tends to waste smaller pieces and uses extra salt, added during the cheese making, as a way to promote good texture and ease of slicing.

Others have used processed cheese or cheese food with fully formed pieces of cheese that are 2 mm square, see Japanese Official Patent Publication H4-320644 published Nov. 11, 1992.

It is therefore a motivation of the invention to provide a novel snack food that is crunchier.

It is therefore a further motivation of the invention to provide a novel snack food that has more volume.

It is therefore a further motivation of the invention to provide a novel snack food that allows the addition of inlay items.

It is therefore a further motivation of the invention to provide a novel less salty cheese snack.

It is therefore a further motivation of the invention to provide a novel method that allows more flexibility in cheese size.

It is a further motivation of the invention to provide a novel way to dry a cheese snack.

### SUMMARY

The present invention solves these needs and other problems in the field of cheese snacks by providing, in the preferred form, a cheese product with a body of a plurality of minced nonmelting cheese pieces unified into a shape having a top and a bottom. The top of the shape is generally parallel with the bottom of the shape. The minced nonmelting cheese pieces have a final moisture content evenly dispersed throughout the body of about 2% to 8%.

In other aspects of the present invention, the top is no more than ½ inches (1.27 cm) from the bottom.

In other aspects of the present invention, the top is between ⅛ and ½ inches (0.3175 and 1.27 cm) from the bottom.

In other aspects of the present invention, the nonmelting cheese is a natural cheese having a pH of greater than about 5.7 and may also be a salt free nonmelting cheese.

In other aspects of the present invention, the minced nonmelting cheese is a processed cheese having a dry cheese solids content and having a melt inhibiting inorganic phosphate salt selected from the group consisting of tetrasodium pyrophosphate, sodium acid pyrophosphate, sodium hexametaphosphate, and mixtures thereof present in an amount of between about 0.5% to 3% by weight based on the amount of dry cheese solids content.

In other aspects of the present invention, the minced nonmelting cheese pieces have a melt value of less than 1.2.

In other aspects of the present invention, a side edge is perpendicular to the top and bottom.

In other aspects of the present invention, the body is in the shape of a disk.

In other aspects of the present invention, the body is in the shape of a hexahedron.

In other aspects of the present invention, the cheese product is free of salt.

In other aspects of the present invention, the cheese product further comprises a plurality of egg pieces unified into the shape with the plurality of minced nonmelting cheese pieces.

In other aspects of the present invention, the cheese product further comprises a plurality of soy protein pieces unified into the shape with the plurality of minced nonmelting cheese pieces.

In other aspects of the present invention, the cheese product further comprises a plurality of meat pieces, such as sausage pieces and bacon bits, unified into the shape with the plurality of minced nonmelting cheese pieces.

In other aspects of the present invention, each of the plurality of minced nonmelting cheese pieces is no greater than ¼ inches by ¼ inches by ¼ inches (0.635 cm by 0.635 cm by 0.635 cm).

In other aspects of the present invention, a method of making a cheese product includes mincing the nonmelting cheese into a plurality of minced nonmelting cheese pieces, filling a form in a forming board with the plurality of minced nonmelting cheese pieces, and drying the plurality of minced nonmelting cheese pieces filled into the form to a moisture content of 8% or less to form a cheese product of a unitized body of minced nonmelting cheese pieces.

In other aspects of the present invention, the forming board is manually filled with a straight edge tool by scraping the straight edge tool along the forming board and leveling the plurality of minced nonmelting cheese pieces with a top surface of the forming board, with the cheese product having a top and bottom that are generally parallel.

In other aspects of the present invention, the form is filled in the forming board automatically with minced nonmelting cheese pieces.

In other aspects of the present invention, the plurality of minced nonmelting cheese pieces is dried in a microwave oven.

In other aspects of the present invention, the plurality of minced nonmelting cheese pieces is dried in a microwave oven for sufficient time that the finished cheese has moisture of less than 8% and has golden brown but not black color.

In other aspects of the present invention, the nonmelting cheese pieces are made by providing nonmelting cheese having an initial moisture content ranging from about 26% to 55% by weight; and mincing the nonmelting cheese into the plurality of nonmelting cheese pieces.

In other aspects of the present invention, the nonmelting cheese is minced into the plurality of nonmelting cheese pieces, and with each one of the plurality of nonmelting cheese pieces being no greater than ¼ inches by ¼ inches by ¼ inches (0.635 cm by 0.635 cm by 0.635 cm).

In other aspects of the present invention, the nonmelting cheese is warmed before mincing.

In other aspects of the present invention, the nonmelting cheese is pressed to have an initial moisture content ranging from about 26% to 55%.

In other aspects of the present invention, the nonmelting cheese has about 10% or more of its whey protein denatured.

In other aspects of the present invention, the nonmelting cheese is a processed cheese having a dry cheese solids content and has a melt inhibiting inorganic phosphate salt of either tetrasodium pyrophosphate, sodium acid pyrophosphate, sodium hexametaphosphate, or mixtures thereof present in an amount of between about 0.5% to 3% by weight based on the amount of dry cheese solids content.

In other aspects of the present invention, the nonmelting cheese has a melt value of less than 1.2.

In other aspects of the present invention, the nonmelting cheese is a natural cheese having a pH of greater than about 5.7 and can be a salt free cheese.

In other aspects of the present invention, the nonmelting cheese includes about 0.5% to 3% by weight of an inorganic melt inhibiting polyphosphate.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 is a top view of a forming board, a straight edge tool, and an in process product used to prepare a finished product having a disk shape according to the preferred teachings of the present invention, with the finished cheese snack depicted in FIG. 3.

FIG. 2 is a side view of the forming board, the straight edge tool and the in process product of FIG. 1.

FIG. 3 is a perspective view of a disk shaped finished product dried cheese piece according to the preferred teachings of the present invention having a preferred disk shape and made by molding the in process product in the forming board of FIG. 1.

FIG. 4 is a top view of a forming board, a straight edge tool and an in process product used to prepare a finished wavy generally hexahedron shaped cheese snack according to the preferred teachings of the present invention, with the wavy generally hexahedron shape of the finished cheese snack depicted in FIG. 6.

FIG. 5 is a side view of the forming board, the straight edge tool and the in process product of FIG. 4.

FIG. 6 is a perspective view of a generally hexahedron shaped finished product dried cheese piece according to the preferred teachings of the present invention having an alternate preferred wavy sided generally hexahedron shape and made by molding the in process product in the forming board of FIG. 4.

All figures are drawn for ease of explanation of the basic teachings of the present invention only; the extensions of the figures with respect to number, position, relationship, and dimensions of the parts to form the preferred embodiments will be explained or will be within the skill of the art after the following description has been read and understood. Further, the exact dimensions and dimensional proportions to conform to specific force, weight, strength, proportions, ratios and similar requirements will likewise be within the skill of the art after the following description has been read and understood.

Where used in the various figures of the drawings, the same numerals designate the same or similar parts. Furthermore, when the terms “side,” “end,” “top,” “bottom,” “first,” “second,” “laterally,” “longitudinally,” “row,” “column,” and similar terms are used herein, it should be understood that these terms have reference only to the structure shown in the drawings as it would appear to a person viewing the drawings and are utilized only to facilitate describing the illustrative embodiments.

### DESCRIPTION OF THE PREFERRED EMBODIMENTS

A dried cheese snack made from a plurality of nonmelting cheese pieces is generally designated 10 in FIG. 3 and generally designated 30 in FIG. 6. The dried cheese snack 10, 30 is also referred to as a cheese piece or a cheese product.

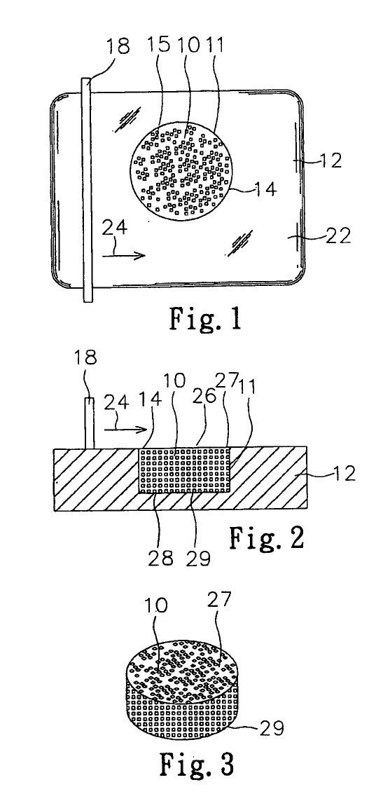

FIGS. 1 and 2 show the dried cheese snack 10 in a forming board 12. The forming board 12 has a top surface 22. According to the preferred teachings of the present invention, the forming board 12 is made of high-density polypropylene. The forming board 12 is, in the preferred form, a rectangle approximately 12 inch×15 inch (30.54 cm×38.1 cm) on a side. Those skilled in the art will recognize that other shapes and sizes may be used for the forming board 12 without deviating from the spirit and scope of the invention. The forming board 12 has a multiplicity of holes or forms 11 manufactured on the top surface 22. On a 12-inch×15-inch (30.54 cm×38.1 cm) rectangular forming board 12, there are 80 forms 11 arranged in an 8×10 array pattern in a preferred form. In the preferred form shown in FIG. 1, each form 11 has a round cavity opening 14 and is circular in cross section of a diameter of 1¼ inch (3.18 cm) and a depth of ¼ inch (0.64 cm). The surface 22 of the forming board 12 and the top opening 26 of each form 11 are parallel to the bottom surface 28 of the form 11. The holes or forms 11 in the preferred form have a depth between approximately ½ inch (1.27 cm) and approximately ⅛ inch (0.635 cm). The forms 11 are manufactured in the forming board 12 using conventional methods including, but not limited to, by drilling.

The forming board 12 is used to create the dried cheese snack 10 by the placement of minced nonmelting cheese pieces 15 into the forming board 12. A straight edge tool 18 is used to level the minced nonmelting cheese pieces 15 by sweeping across the top surface 22 of the forming board 12 to fill the forms 11. The straight edge tool 18 is slid in direction of arrow 24 over surface 22 of the forming board 12 to deposit the minced nonmelting cheese pieces 15 into the forms 11. The sweeping action of the straight edge tool 18 fills the form 11 and prevents overloading of the forming board 12 with the minced nonmelting cheese pieces 15.

The dried cheese snack 10 is in the form of a disk formed in the form 11 of FIGS. 1 and 2 is shown in FIG. 3 and has a top 27 and a bottom 29. The top 27 is generally parallel to the bottom 29 to allow for an even thickness. This geometry promotes even drying of the dried cheese snack 10.

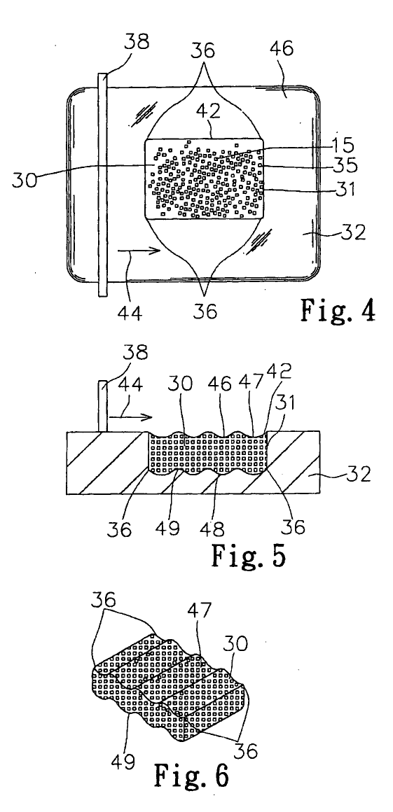

FIGS. 4 and 5 show the alternate dried cheese snack 30 according to the preferred teachings of the present invention being formed in a forming board 32. The forming board 32 has a form 31 in the shape of a hexahedron with a generally rectangular opening 42. In the preferred form, the forming board 32 is 10½ inches (26.67 cm) by 11¾ inches (29.85 cm) that will accommodate 12 forms 31 in a 2×6 array. The forms 31 are 4½ inches by 1½ inches (11.43 cm by 29.84 cm by 3.81 cm) and are ½ inches (1.27 cm) deep. The form 31 has a wavy top 46 and a wavy bottom 48. The dried cheese snack 30 is formed in the forming board 32 where the straight edge tool 38 sweeps in direction 44 to fill the form 31 with minced nonmelting cheese pieces 15.

FIG. 6 shows the product of the forming board 32 as the dried cheese snack 30 made of minced nonmelting cheese pieces 15 that has been baked according to the methods described herein. The dried cheese snack 30 has a wavy top 47 and a wavy bottom 49 that, according to alternate embodiments according to the preferred teachings of the present invention, are in the shape of a polyhedron, in the preferred form, a hexahedron. Specifically, the dried cheese snack 30 has uniform thickness in its cross-section and has ridges as shown in FIG. 5. Those skilled in the art will recognize that other shapes for the wavy top 47 and the wavy bottom 49 may also be employed to make the dried cheese snack 30 and is not limited to the shapes shown.

The holes or forms 31 have rounded corners as viewed from the top surface 46 to create the dried cheese snack 30 with corners 36 having a uniformly drying roundness having a final moisture content of about 2% to 8%. The rounded corners of forms 31 should have a radius of at least ¼ inch (0.64 cm) and preferably 0.437 inches (1.11 cm). In one embodiment according to the preferred teachings of the present invention, each corner of form 31 is a quarter circle, with the circle having a radius of 0.437 inches (1.11 cm).

In an alternative aspect according to the preferred teachings of the present invention, inlay items 35 can be included with the minced cheese pieces 15. Specifically, inlay items 35 in the form of sausage pieces can be used, as well as other materials such as meat protein, bacon bits, egg pieces, and soy protein pieces. After drying, these inlay items 35 will be unified into the cheese snack body 10, 30 along with the minced nonmelting cheese pieces 15. Different inlay items 35 may also be mixed in a single cheese snack 30. For example, egg pieces can be mixed with bacon bits in a single cheese snack 30. As much as 65% of the cheese snack 10, 30 can be inlay items 35, with a most preferred range depending on the type of nonmelting cheese and inlay item 35. As an example, if dry soy protein is used as the inlay item 35, the starting moisture content of the minced nonmelting cheese pieces 15 can be higher. One preferred form mixes 50% minced nonmelting cheese pieces 15 and 50% inlay items 35. The selection and ratios of inlay items 35 and minced nonmelting cheese pieces 15 according to the teachings of the present invention will affect the cheese snack 10, 30 formed. For example, in a preferred form, 2 parts cheese and 1 part soy protein will produce a delicious cheese snack 10, 30. As another example, in the preferred form, 20 parts cheese and 1 part bacon bits will produce a delicious cheese snack 10, 30.

In summary, according to the preferred teachings of the present invention, the cheese snack 10, 30 can be made by: taking cheese-that-does-not-melt, mincing it into minced nonmelting cheese pieces 15, optionally adding inlay items 35, and pouring the minced nonmelting cheese pieces 15 and/or inlay items 35 into forms 11, 31 of forming boards 12, 32 so that they overfill the forms 11, 31, then leveling, and then drying the inlay items 35 and/or the nonmelting cheese pieces 15 to unify inlay items 35 and/or the nonmelting cheese pieces 15 into a unified body.

Providing a nonmelting cheese includes making or selecting a cheese that does not melt. As used herein, a “nonmelting” cheese is meant a cheese whose base area increases by less than 20% (less than 0.3 square inches (1.94 cm.)) when cut into a cube of one-half inch (1.27 cm) per side and placed for five minutes in an oven preheated to 350° F. (176.7° C.). Thus, such a nonmelting cheese has a “melt value” (i.e., a ratio of surface area after heating divided by initial surface area) of less than 1.20. Even more preferred for use herein are nonmelting cheeses having melt values of about 1.0 to 1.1.

Selecting a nonmelting cheese is important to the realization of the desirable textural features of the finished dried cheese product herein. Also, selecting a nonmelting cheese is important to obtaining a finished final product having the desirable finished shape attributed herein.

Cheese making is a well developed art and the skilled artisan will have no difficulty making a nonmelting cheese having the particular selected features required for use herein. Generally however, useful nonmelting cheese will be either natural cheese having suitable nonmelting characteristics or, less preferably, processed cheese products that are nonmelting.

A nonmelting cheese can be prepared by making certain natural cheeses with a pH above about 5.7, by making a lower pH natural cheese that does not melt, or by making a processed cheese that essentially includes a melt inhibiting inorganic mixing ingredient such as a orthophosphate or polyphosphate. Suitable for use herein and permitted for use in cheese in the U.S. as the inorganic phosphate are orthophosphate materials such as tetrasodium pyrophosphate, sodium acid pyrophosphate, sodium hexametaphosphate, and mixtures thereof.

A “natural” cheese is to be distinguished from a processed cheese. Natural cheese is a protein-based matrix formed by trapping milk fat between linked protein micelles. Protein micelles are the fraction of the protein casein that is left after the coagulant (rennet/chymosin) has separated the kappa-casein from the rest of the casein molecule. These protein micelles have a negative ionic charge. In a natural cheese of pH. 5.7 or higher, the protein micelles are held in a rigid structure by positively charged calcium ions that associate between them. The milk fat and water are trapped in this rigid matrix caused by the attraction between the opposing charges of the protein micelles and the calcium ions.

A processed cheese is a cheese product that results from mixing cheese ingredients such as commuted cheeses of one or more types, blending the cheese(s) and cheese and/or milk derived materials together with emulsifiers and stabilizers, gums, caseinates, or other ingredients with the aid of mixing and heat to form an homogeneous blend and forming the blend into bricks, slices or otherwise packaging the product.

In contrast, a natural cheese is one that has not been so processed. Rather, the milk, optionally flavored with-desired spices, is treated to form a cheese. Such natural cheeses then are desirably free (i.e., contain less than 0.5%) of any emulsifiers, gums, starches, added caseinates or heat coaguable materials such as egg white, starch, soy protein pieces, or other ingredients not supplied in the starting milk material that a processed cheese product might contain.

Moreover, processed cheeses are generally formulated and prepared especially to have good melt characteristics. Conventional, typical processed cheeses are generally easily meltable and assume a smooth fluid form at low temperatures (about 150° F., 65° C.). A processed cheese is a cross-linked protein matrix but not one that is a naturally formed matrix of proteins. For common processed cheese, (e g., “American, cheese sauces, etc.), emulsifying salts are used that release their bonds at relatively low temperatures. For example, an “American” cheese melts easily at low temperatures (about 150° F., 65° C.) and cheese sauces are not solid at room temperature. Most processed cheeses thus have emulsifiers added to increase their meltability.

It is believed herein that as the pH of a natural cheese is lowered, the calcium ions tend to go into solution and are no longer associated with the casein. Consequently, with fewer linkages between the protein micelles, the structure of the cheese weakens and thus melts more easily. While not wishing to be bound herein to the proposed theory, to insure sufficient strength to be nonmelting, preferred for use herein are nonmelting natural cheeses having a pH of about 5.3 to about 6.7, more preferably about 6.0 to about 6.4, and for best results about 6.1 to about 6.3.

In the case of natural nonmelting cheese, it is also preferred that the cheese have had minimal proteolysis of its casein. A cheese whose Beta casein fraction includes minimal proteolysis may be more preferable. These cheeses may be made by using either direct vat acidification or by using a cheese culture whose growth can be arrested before the pH of the cheese is lowered below about 5.7.

Even more preferred are fresh, high pH (5.7 or more) cheeses that have been pressed to 26%-55% moisture levels. Lower moisture cheeses are preferred primarily since such cheeses are easier to dry without browning or burning the cheese. Such fresh cheeses include Queso Blanco, Ackawi (especially pressed Ackawi), Queso Fresco (especially pressed Queso Fresco), Panela (especially pressed Panela), Queso Para Freir (especially pressed Queso Para Freir), Paneer (especially pressed Paneer), and other ethnic fresh cheeses. Most preferred are these fresh cheeses when their moisture has been reduced to 39-41% and they are made using whole milk (3.7% or more of butterfat) and 3.1% or more of protein. Low fat versions of these cheeses can also be used, but are less preferred, by removing fat from the milk in the make process to obtain 1.0%-2.0% butterfat milk.

Certain cheeses including some that are commercially available that are unsuitable for use herein by virtue of excessive moisture content but which otherwise are suitable can be made useful herein by simple pressing, controlling the cook temperature of the curd, the size of curd pieces that are cut in the make vat, the amount of time that the curd is held at elevated temperatures while being stirred in the make vat, and other well known factors, to remove excessive incorporated moisture.

Increasing the amount of denatured whey protein contained therein can also influence the melt resistance characteristics of a cheese. Pasteurizing the cheese milk at temperatures higher than 175° F. tends to denature the whey protein. As more denatured whey protein is incorporated into the cheese matrix, the matrix is strengthened. The matrix strengthening is independent of pH thus allowing for use of lower pH cheeses such as Indian Paneer cheese. Preferably, at least 10% of the whey proteins are denatured in the starting cheese. For better results, about 10% to 50% of the whey proteins present is denatured.

According to the preferred teachings of the present invention, the minced nonmelting cheese pieces 15 can be a mixture of various kinds and numbers of cheese. For example, in a preferred form, 2 parts Ackawi cheese is minced with 1 part Queso Blanco cheese and 1 part pressed Queso Blanco cheese.

It is preferred that the cheese, whether natural or processed cheese or a mixture thereof, be prepared with a moisture content not to exceed about 55% by weight. For the purposes of this invention, such a moisture content may be referred to as an initial moisture content or as a natural initial moisture content. Preferably, such a moisture content lies in the range of about 26% to 55% by weight. A range of about 26% to about 43% by weight is even more preferred. A range of about 39% to about 41% by weight is most preferred.

The desired initial moisture content can be controlled by conventional cheese making processes such as by pressing the cheese, whether natural or processed or a mixture thereof, in a conventional cheese press. In the case of a processed cheese, limiting the amount of water added to the cheese mixture can further control the initial moisture content.

In further aspects of the present invention according to the preferred teachings of the present invention, the nonmelting cheese used to make the minced nonmelting cheese pieces 15 and minced nonmelting cheese pieces 15 is a less salty nonmelting cheese. To make the less salty product requires the adherence to the methods according to the preferred teachings of the present invention particularly with regard to cheeses that do not melt. Those skilled in the art will recognize that traditional methods of making less salty nonmelting cheeses involve either shorter brine time, which produces cheese with higher lactose content that burns during baking. The alternate method of making nonmelting cheeses less salty is the direct application of less salt after the curd has been separated from the whey but before it has been formed in hoops. This method limits the amount of drain time for the cheese, hence, increasing its lactose content. To reduce lactose in nonmelting cheese, the curd may be “washed”. This “washing” process involves addition of large volumes of fresh water after most or all of the whey has been removed from the curd. Unfortunately, this process also increases the crumbliness of the cheese. Taking the cheese out of the brining process quickly can make a low salt and a low lactose cheese. The resultant cheese is not easy or commercially feasible to slice but can be minced. The direct application of a block or a knit process does not need a brine and results in a crumbly cheese with no salt content as is known in the art. For example, a no salt cheese such as Paneer is used with inlay items 35, preferably from 35%-45% minced Paneer. This results in a salt free cheese.

After the cheese making process, the nonmelting cheese is minced to create the minced nonmelting cheese pieces 15 so that the minced nonmelting cheese pieces 15 are well suited for baking into crunchy products, such as for use in the nonmelting cheese snack 10. According to the preferred teachings of the present invention, a conventional bowl cutter is used to break, also known as mincing, the cheese into pieces 15 according to the preferred teachings of the present invention that are less than ¼-inch (0.635 cm) diameter and ideally less than ⅛-inch (0.3175 cm) diameter but preferably no thinner than about 1/16 inch (about 1.5875 mm). In a preferred form, the nonmelting cheese is minced into cubes of ⅛×⅛×⅛ inches (0.3175×0.3175×0.3175 cms) in size. The minced nonmelting cheese pieces 15 can be as small as a 1/16 inch (0.155375 cm) cube or as large as a ¼ inch (0.635 cm) cube. The desired thickness may depend upon the type of cheese and the amount of fat and moisture in the cheese as well as the desired configuration of the cheese snack 10, 30.

Then, a dry powder such as cellulose is added to keep the product free flowing so that it can later be easily poured into forms 11, 31 of the forming boards 12, 32. The ratio of dry powder to cheese is in the range, by volume, of 1:25 to 1:50. The amount of time that the cutter works on the product is designed to limit the amount of fat released from the cheese. The cheese is warmed to 45° F.-65° F. (7 2/9° C.-18⅓° C.) before being placing in the cutter to avoid shattering the curd and releasing too much fat. The minced nonmelting cheese pieces 15 and dry powder are able to flow freely when removed from the cutter.

If inlay items 35 are desired according to the teachings of the present invention, the desired material for inlay items 35 can be added to the bowl cutter with the nonmelting cheese to be simultaneously minced therewith. Alternatively, inlay items 35 of the appropriate size can be thoroughly mixed with the minced cheese pieces 15 before being filled into the forms 11, 31.

Inlay items 35 and/or cheese pieces 15 can be filled in forms 11, 31 as set forth. The filling can be done manually or automatically by an automated filler. In the preferred form, forms 11, 31 are over-filled with inlays 35 and/or minced nonmelting cheese pieces 15 so that excess is mounded above the surface 22, 42 of the forming board 12, 32. The excess is then scraped off so that the remaining inlays 35 and/or minced nonmelting cheese pieces 15, in the form 11, 31, has a top 27, 47 that matches the top opening 26, 46 of the form 11, 31 and has a bottom 29, 49 that matches the bottom 28, 48 of the form 11, 31.

After filling in forming boards 12, 32, the minced nonmelting cheese pieces 15 and inlays 35 are dried from their initial or native moisture content to their finished or dried moisture content. Preferably, the minced nonmelting cheese pieces 15 and inlays 35 are dried at atmospheric pressure exclusively with dielectric heating such as with microwave or radio wave frequency to their final moisture content. The drying process unifies the minced nonmelting cheese pieces 15 into a shape having a top 27, 47 and a bottom 29, 49, with the top 27, 47 of the shape generally parallel with the bottom 29, 49 of the shape 10, 30, and with the plurality of minced nonmelting cheese pieces 15 having a final moisture content evenly dispersed throughout the body 10, 30 of about 2% to 8%. Such exclusive dielectric heating to dry the cheese pieces 15 reduces the chance of undesirably creating an exterior dry crust. Moreover, in an embodiment of the present invention used to fabricate cheese snacks 10, 30 having a complex three-dimensional shape, exclusive usage of dielectric drying facilitates production of such complex shapes. Microwaving the nonmelting cheese readily heats the cheese and thus readily drives moisture out of the cheese. Further, microwaving heats the cheese from the inside. Accordingly, some of the hard-to-reach moisture remaining in an already dried cheese is efficiently driven out with microwave energy. Microwaving further avoids forming a moisture-retaining crust.

While microwave drying is the preferred method for finish drying the present nonmelting cheese, any form of dielectric heating can also be employed. Dielectric heating, or equivalently in the art “high frequency” heating is used in its conventional sense (see, for example, “Industrial Microwave Heating,” A C. Metaxas and R. J. Meredith, 1983, pg. 2) to include both portions of the microwave (10 GHz to 300 MHz) and the radio (300 to 3 Mhz) frequency ranges.

The dielectric heating, e.g., microwave, or drying step is preferably practiced at atmospheric pressure. At reduced pressures, the cheese can tend to vaporize the internal moisture too quickly causing the product to undesirably puff or otherwise deform.

The cheese snack 10, 30 is dried until their moisture level has been reduced to a final moisture content of between about 2% and about 8% by weight and the minced nommelting cheese pieces 15 and inlays 35 have fused into a unitary body. A more preferred range for the final moisture content is from about 2% to about 4% by weight. Cheese snacks 10, 30 have a golden brown but not black color.

In practice, especially using lower power or capacity microwave units such as are used for home or institutional food preparation, the microwave drying step can be practiced in two, three, or more substeps. After each substep, it has been found helpful to vent briefly the microwave heating unit to release entrained moisture, In commercial practice or using microwave equipment designed for rapid removal of moisture from the material being processed, such venting is less desired. The period of venting, however, should be only sufficient to accomplish the venting and not be allowed to continue so long as to allow the intermediately dried product to cool to room temperature.

After drying the forming boards 12, 32 are emptied into a bin and seasoning can be applied before consumption or packaging. Various seasoning materials can be applied to the dried cheese snacks 10, 30. Application immediately after the drying process as compared to either pre-drying or post-cooling application of the seasonings, particularly those seasonings in dry particulate form, adhere to the minced nonmelting cheese pieces 15 especially well. It is believed that liquid fat created during the microwave heating and drying step entrains the seasoning material. Such a phenomenon not only improves the physical adherence of the seasoning material but also, surprisingly, greatly increases the flavor impact of the seasoning. At conventional seasoning usage levels, the flavor impact is enhanced. If desired, however, the usage of costly seasoning materials can be reduced and yet obtain finished products exhibiting comparable flavor levels to that obtained with either pre-drying or post-cooling application at higher seasoning usage levels.

Since puffing of the cheese is undesirable, the cheese starting material is desirably free of any leavening or gas producing ingredients. The finished products are essentially further characterized as being substantially unpuffed. “Unpuffed” herein is meant that the finished product rises less than about 20% from its predrying dimension.

The finished product is further desirably as being unpocked. A pocked or “lacy” product is one if on its flat surface it has many holes that are large enough and/or covered with a sufficiently thin film of cheese so that one can either see through the holes or the holes are translucent under normal lighting conditions. By “many” is meant at least on average of one visible hole per square centimeter.

### EXAMPLE 1

This example sets out the manufacturing steps for making the nonmelting cheese and the steps for mincing and microwave drying the nonmelting cheese.

Milk with the following composition is selected; water (87.2%); fat (3.9%); casein (2.5%); albumen (0.7%); milk sugars (5.0%); and ash (0.7%).

The milk is then pasteurized for 30 seconds at 183° F.-184° F. (83.8° C.-84.4° C.) in a High Temperature Short Time Pasteurizer to incorporate denatured whey proteins into the final cheese product. These denatured whey proteins help the final cheese product resist melting. Using a metering injection pump, phosphoric acid is injected into the raw milk line leading to the regeneration section. The milk is acidified to a pH of 6.25-6.35 as the milk enters the vat.

The ingredients for the cheese make procedure are as follows: the pasteurized milk; rennet (microbial rennet with sodium chloride and sodium benzoate as preservative agents) in an amount of three ounces (85 gm) per one thousand pounds (454.5 kg) of milk; and calcium chloride in an amount of two to six ounces (57-170 gm) per one thousand pounds (454.5 kg) of milk. The rennet is diluted with forty volumes of cold, chlorine-free water before being mixed with the pasteurized milk. The calcium chloride is also diluted with forty volumes of cold chlorine-free water before being mixed with the pasteurized milk. It should be noted that calcium chloride meets the specifications of food chemical codes.

The cheese making procedure is as follows:
a. Set temperature (91° F.-93° F. (32.8° C.-33.9° C.)).
b. Set time (25-35 minutes).
c. Curd knife size (about ⅜ inch (9 mm) cut).
d. Heal time (8-10 minutes).
e. pH at cut (6.25-6.35).
f. After the cut, the cheese curds and whey are gently agitated for five minutes.
g. The curds and whey are then heated to 110° F.-112° F. (43.3° C.-44.4° C.) for 30 to 35 minutes.
h. The agitation speed is then increased slightly (5-10%) and the heat is turned off. The agitation of the curds and whey is continued for 5-10 minutes.
i. The agitator is stopped, and 50% of the volume of whey is drained off.
j. The remaining curds and whey are agitated for 15 to 20 minutes.
k. The remaining whey is drained.
l. After all the whey has been drained, flake salt is added to the curd in the amount of 2-8% of the curd weight. The curd is agitated while the salt is being added.
m. While the salt is being added (or optionally after the salt has been added), herb and garlic seasoning can be added (or optionally other flavorings can be added).
n. When all the salt has been dissolved, the cheese curds are placed in hoops for pressing.
o. The cheese curds are then pressed at 25-35 pounds (11.4-15.9 kg) of pressure for 10 hours or longer such that the finished cheese includes a pH of 6.1 to 6.25 and a moisture content of between 39% and 41% by weight. The cheese has a melt value of less than 1.2.
p. The cheese is then minced into minced nonmelting cheese pieces 15 of less than ¼ inch (0.64 cm)×¼ inches 0.64 cm) in dimension.
q. The minced nonmelting cheese pieces 15 are placed in the forming board 12, 32 and leveled off.
r. Forming boards 12, 32 are placed in a microwave oven at 700 watts (as measured by the 2-liter method) for three to eight minutes or until the final product moisture has been reduced to less than 8% by weight.
s. The cheese snacks 10, 30 are removed from the forms 11, 31 by tipping out of the forming boards 12, 32. They may be immediately packaged, seasoned or further processed because they are not excessively hot due to the relative lack of moisture.

The methods of the present invention yield a dried cheese snack 10, 30 that has the following characteristics. The production methods have the ability to shape the cheese snack 10, 30 into any shape including more fanciful and/or irregular so long as its top 27, 47 and bottom 29, 49 follow each other, for example in one preferred form are wavy, forming ridges, but parallel as shown in FIG. 6 and in another preferred form shown in FIG. 3 parallel planes giving a flat appearance. Shapes can be round discs, generally hexahedron shaped “bars”, or other shapes as long as all corners 36 are rounded, because sharp corners do not bake thoroughly; the corners 36 have a uniformly drying roundness that allow them to bake thoroughly.

More air is incorporated into the dried cheese snack 30 by mincing the nonmelting cheese to form minced nonmelting cheese pieces 15 than when the nonmelting cheese is simply sliced and baked. Additionally, it is believed that cheese releases moisture and fat when minced as a result of breakage of some protein matrixes. This free moisture vaporizes during drying and enlarges the spaces between inlays 35 and/or the minced nonmelting cheese pieces 15 for creating larger air pockets. The extra air makes the cheese snack 10, 30 taste crunchier and gives it more volume. The latter improves the consumer's perception of value.

It is less expensive to make cheese for mincing than for slicing since broken slices cannot be used in the prior art cheese making technology. For example, the trim and broken pieces from production of all sorts of nonmelting cheese may be used as starting cheese elements according to the preferred teachings of the present invention. These trim/broken pieces would otherwise be sold at a low price. Additionally, in an alternate preferred form, crumbly cheese which could not be sliced in a commercially feasible manner can be used for the minced nonmelting cheese pieces 15.

The present invention allows a reduced cost of snack pieces 10 and 30 as inlay items 35, such as sausage pieces, meat protein, egg pieces, bacon bits and soy protein pieces which are less expensive than cheese can be incorporated into snack pieces 10, 30. Those skilled in the art will recognize that prior art processes do not allow this capability because the cheese could not incorporate such inlays and still be sliced in a commercially feasible manner.

Each cheese snack 10, 30 according to the teachings of the present invention is less breakable than baked slices. That is because the cheese snacks 10, 30 are thicker without becoming hard to eat because more air is incorporated than is possible with dried sliced cheese snacks. For example the cheese snack 10, 30 could be twice as thick as a cheese product made from a cheese slice. Preferably, the cheese product, piece or dried cheese snack 10, 30 should not be too thick because this leads to a consumer perception that there are too few pieces in each package. Also, preferably, making the product too thin leads to physical breakage in transit.

Generally, less salty nonmelting cheese is harder to slice than more salty nonmelting cheese that have a salt content of generally 1½% or greater. Since the nonmelting cheese can be minced and does not need to be sliced, a less salty nonmelting cheese (less than 1½% salt) may be used according to the teachings of the present invention. Those skilled in the art will appreciate that this will result in cheese snacks 10, 30 of a less salty taste.

The cheese snack 10, 30 exhibits sufficient mechanical strength to resist breakage. The cheese snacks 10, 30 are breakage resistant and endure routine handling associated with packaging and distribution without forming excessive amounts of either broken pieces or fines.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalents of the claims are intended to be embraced therein.

1. A cheese product comprising:
a body of a plurality of minced nonmelting cheese pieces unified into a shape having a top and a bottom, with the top of the shape generally parallel with the bottom of the shape, and with the plurality of minced nonmelting cheese pieces having a final moisture content evenly dispersed throughout the body of about 2% to 8%.

2. The cheese product of claim 1 having at least one corner, with the at least one corner including a uniformly drying roundness having a final moisture content of about 2% to 8%.

3. The cheese product of claim 1 with the body generally in the shape of a disk.

4. The cheese product of claim 1 with the body generally in the shape of a hexahedron.

5. The cheese product of claim 1 with the top and bottom having a wavy shape.

6. The cheese product of claim 1 with one of the plurality of minced nonmelting cheese pieces further comprising a salt free cheese.

7. The cheese product of claim 1 with the body further comprising a plurality of sausage pieces unified into the shape with the plurality of minced nonmelting cheese pieces.

8. The cheese product of claim 1 with the body further comprising a plurality of egg pieces unified into the shape with the plurality of minced nonmelting cheese pieces.

9. The cheese product of claim 1 with the body further comprising a plurality of bacon bits pieces unified into the shape with the plurality of minced nonmelting cheese pieces.

10. The cheese product of claim 1 with the body further comprising a plurality of soy protein pieces unified into the shape with the plurality of minced nonmelting cheese pieces.

11. The cheese product of claim 1 with each of the plurality of minced nonmelting cheese pieces being no greater than ¼ inch by ¼ inch by ¼ inch.

12. The cheese product of claim 1 with the minced nonmelting cheese pieces being formed from crumbly cheese.

13. The cheese product of claim 1 with the minced nonmelting cheese pieces having less than 1.5% salt.

14. The cheese product of claim 1 with the minced nonmelting cheese pieces being formed from low lactose cheese.

15. Method of making a cheese product comprising:
a) mincing a nonmelting cheese into a plurality of minced nonmelting cheese pieces;
b) filling a form in a forming board with the plurality of minced nonmelting cheese pieces; and
c) drying the plurality of minced nonmelting cheese pieces filled into the form to a moisture content of 8% or less to form a cheese product of a unitized body of minced nonmelting cheese pieces.

16. The method of claim 15 with the filling a form in a forming board comprising manually filling the form with a straight edge tool by scraping the straight edge tool along the forming board and leveling the plurality of minced nonmelting cheese pieces with a top surface of the forming board, with the cheese product having a top and bottom that are generally parallel.

17. The method of claim 15 with the filling a form in a forming board comprising automatically filling the form with minced nonmelting cheese pieces.

18. The method of claim 15 with drying the plurality of minced nonmelting cheese pieces comprising drying in a microwave oven.

19. The product prepared by the method of claim 15.

20. The method of claim 15 with mincing the nonmelting cheese comprises mincing the nonmelting cheese into the plurality of nonmelting cheese pieces, and with each one of the plurality of nonmelting cheese pieces being no greater than ¼ inch by ¼ inch by ¼ inch.

21. The product prepared by the method of claim 20.

22. The method of claim 15 with mincing the nonmelting cheese made by:
a) providing salt free nonmelting cheese; and
b) mincing the nonmelting cheese into the plurality of nonmelting cheese pieces.

23. The method of claim 15 with mincing the nonmelting cheese made by:
a) providing low lactose nonmelting cheese; and
b) mincing the nonmelting cheese into the plurality of nonmelting cheese pieces.

24. The method of claim 15 with mincing the nonmelting cheese made by:
a) providing crumbly nonmelting cheese; and
b) mincing the nonmelting cheese into the plurality of nonmelting cheese pieces.

25. The method of claim 15 with mincing the nonmelting cheese made by:
a) providing nonmelting cheese having less than 1.5% salt; and
b) mincing the nonmelting cheese into the plurality of nonmelting cheese pieces.

26. The method of claim 15 with mincing the nonmelting cheese made by:
a) warming the nonmelting cheese to between 45° F.-65° F. (7 2/9° C.-18⅓° C.) and
b) mincing the nonmelting cheese into the plurality of nonmelting cheese pieces after warming the nonmelting cheese to between 45° F.-65° F. (7 2/9° C. -18⅓° C.).
